(19) United States
(12) Patent Application Publication
(10) Pub. No.: US 2017/0187014 A1
(43) Pub. Date: Jun. 29, 2017

(54) HOUSING FOR A PLURALITY OF BATTERY CELLS, COMPRISING THREE MAIN COMPONENTS

(71) Applicant: Robert Bosch GmbH, Stuttgart (DE)

(72) Inventors: Sandro Rank, Stuttgart (DE); Carsten Mueller, Stuttgart (DE); Jens Boehme, Gerlingen (DE); Johannes Federle, Rottenburg (DE); Lisa Lorenz, Stuttgart (DE); Ruben Jung, Stuttgart (DE)

(21) Appl. No.: 15/325,375

(22) PCT Filed: Jun. 29, 2015
(86) PCT No.: PCT/EP2015/064723

§ 371 Date: Jan. 10, 2017

(30) Foreign Application Priority Data
Jul. 11, 2014 (DE) 102014213586.9
Oct. 24, 2014 (DE) 102014221707.5

(51) Int. Cl. H01M 2/10; H01M 10/48; H01M 10/42

(52) U.S. Cl. CPC H01M 2/1077; H01M 10/425; H01M 10/48; H01M 10/486; H01M 2010/4271; H01M 2220/20

(57) ABSTRACT

The invention relates to a housing (5; 10, 20, 30) for a plurality of battery cells (40). The housing (5; 10, 20, 30) comprises three main components (10, 20, 30). A first main component is formed by a container (10) for receiving a plurality of battery cells (40), a second main component is formed by a support (20) for electric and/or electronic components (22), and a third main component is formed by a cover (30). According to the invention, the electric and/or electronic components (22) are additionally arranged at least partly on a circuit board (24). The invention further relates to a battery cell module (50), to a motor vehicle with a battery cell module (50), and to a method for producing a battery cell module.

### BACKGROUND OF THE INVENTION

The present invention relates to a housing for a multiplicity of battery cells, comprising three main components, a battery cell module, a motor vehicle having the battery cell module, and a method for producing a battery cell module.

There is a considerable requirement worldwide for batteries for wide ranges of application, for instance, on the one hand, for stationary installations such as, for example, wind turbines or solar power plants, but also, on the other hand, for mobile electronic appliances such as, for example, laptops and communication devices. Not least, it can be anticipated that the requirement for batteries for vehicles, such as, for example, for hybrid and electric vehicles, will increase in the coming years. These batteries have to meet very stringent requirements with respect to reliability, service life and performance.

Typically, for this purpose a plurality of battery cells are electrically connected to each other in a series connection and/or parallel connection in order to form powerful battery cell modules. In addition, a battery cell module also comprises the electronics system necessary for proper operation of the battery cells.

Usually, a housing protects the differing constituent parts of the battery cell module against harmful external influences, for instance against moisture. In addition, the housing provides the necessary strength and mechanical stability for receiving and fastening all components necessary in the battery cell module. Also, and especially in the case of the action of an exceptionally strong force that may be expected, for example, in the case of an accident, the housing protects the components against damage.

Usual battery houses typically have two housing parts, which can be connected to each other. Thus, for example, a battery housing constituted by a receptacle and a cover is known from US 2012/0129028 A1.

Further developments show battery housings composed of two housing parts, in which the cover may also have electrical components. Thus, for instance, a battery module cover that has cell connectors and strip conductors integrated therein is described in DE 10 2012 221 751 A1. While the cell connectors can electrically connect the individual batteries of the battery module to each other, the strip conductors can be connected to a sensor, and thus establish an electrical connection for transmitting measurement data between the sensor and the points on the battery cells that are to be measured.

A further battery module cover having electrical components integrated therein is known from DE 10 2012 205 019 A1. Besides cell connectors, the battery module cover also comprises voltage tap points, temperature sensors and a signal line system.

On the one hand, the approach, known from the prior art, of disposing electrical components directly one a cover of a battery housing, offers the advantage of a particularly compact structure of the battery housing, since only two main constituent parts—namely, a receptacle for the battery cells and a cover—are required for the battery housing. On the other hand, the cover, as an outermost housing component, is directly exposed to the external influences. In the case of action of an external force, for instance, the purpose of the cover is precisely that the structural components disposed inside the housing be protected, if necessary at the expense of the cover. It follows from this that the electrical structural elements disposed directly on the cover are in principle likewise exposed to a greater risk, in the case of such damage, than those that are disposed, not directly on the cover, but somewhat further inside the housing.

Thus, known from EP 2 450 982 B1, for example, is a battery housing in which a plate element having cell connectors (“busbars”) is provided, the plate element being disposed between a container for the battery cells and a cover. Besides the cell connectors, no further electrical and/or electronic components on the plate element are described.

### SUMMARY OF THE INVENTION

The housing according to the invention for a multiplicity of battery cells comprises three main constituent parts. A first constituent part is realized by a container for receiving a multiplicity of battery cells, a second main constituent part is realized by a support for electrical and/or electronic components, and, finally, a third constituent part is realized by a cover. It is additionally required, according to the invention, that the electrical and/or electronic components be disposed, at least partly, on a printed circuit board (PCB).

The invention is based, firstly, on the recognition that the diverse components in a battery cell module differ in their sensitivity with respect to tightness of seal and/or cleanness of a housing receiving the components. Thus, for instance, battery cells in principle are less sensitive than the electronics system that constitutes the entirety of the electrical and/or electronic components. Accordingly, the requirements for tightness of seal and/or cleanness of the housing are less for the battery cells than those for the electronics system. It is therefore proposed, according to the invention, to provide mutually delimited regions in the housing for the battery cells, on the one hand, and for the electrical and/or electronic components, on the other hand. The invention thus provides, on the one hand, a container for the battery cells and, on the other hand, a support for electrical and/or electronic components.

Advantageously, this measure has the result that it dispenses with the need for the interior region of the entire housing, i.e. the entire interior region that is constituted by the container, the support and the cover, to be sealed in an elaborate manner against the external environment of the housing. Instead, it is now sufficient to ensure a high degree of tightness of seal and/or cleanness only for a sub-region of the entire housing, namely, for the interior region of the support for electrical and/or electronic components. In particular, advantageously, it is entirely sufficient if the greatest possible protection against moisture is required only for the particular sub-region, and not for the entire interior region of the housing.

The invention is based on the further recognition that the requirement for tightness of seal and/or cleanness of the housing can be reduced yet further if the electrical and/or electronic components are disposed, at least partly, on a printed circuit board. On the one hand, the required electronics system can thus be disposed on the smallest space, i.e. the region at which there are greater requirements for tightness of seal and/or cleanness is advantageously reduced further. On the other hand, a printed circuit board also offers the possibility of covering at least parts of the electronics system by a protective layer, i.e. strip connectors, for instance, may be routed in a layer system of the printed circuit board, and thus be provided with optimum protection against possible harmful effects from the interior of the housing.

Finally, the separate, additional covering of the housing also reduces the risk of the electrical and/or electronic components being exposed to the direct external influence.

Overall, owing to the technical features according to the invention, the safety of the battery cell module is optimized, in particular that of the electrical and/or electronic components, without the need for elaborate measures.

Advantageous developments of the invention are specified in the dependent claims and described in the description.

### BRIEF DESCRIPTION OF THE DRAWINGS

Exemplary embodiments of the invention are explained in greater detail on the basis of the drawings and the description that follows. There are shown in:

FIG. 1 an embodiment of the housing according to the invention, having three main constituent parts and battery cell modules, in an exploded representation,

FIG. 2 a first snapshot in the method for producing a battery cell module,

FIG. 2 a second snapshot in the method for producing a battery cell module,

FIG. 4 a third snapshot in the method for producing a battery cell module, and

FIG. 5 a fourth snapshot in the method for producing a battery cell module.

### DETAILED DESCRIPTION

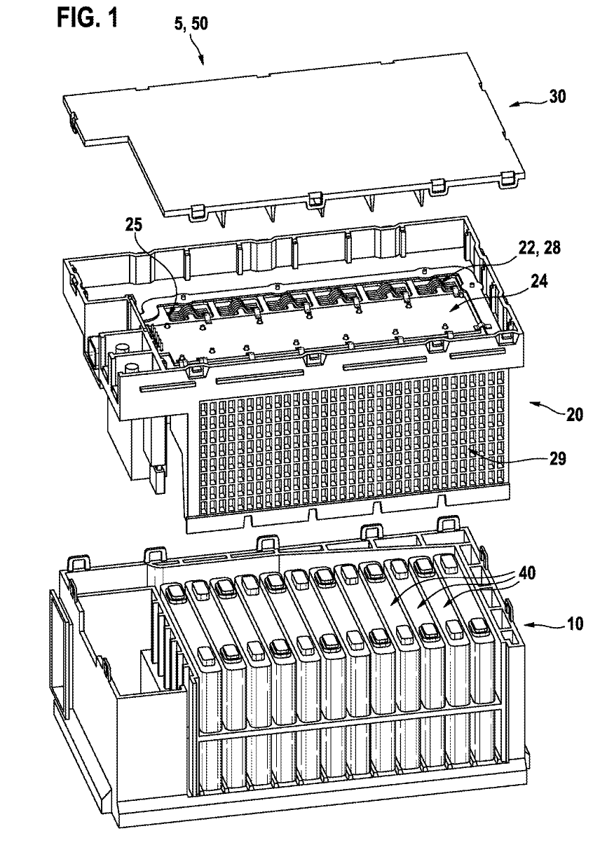

A first exemplary embodiment of the housing according to the invention for a multiplicity of battery cells is explained with the aid of the drawing realized as an exploded representation in FIG. 1. In principle, the invention provides a housing 5; 10, 20, 30 for a multiplicity of battery cells 40, wherein the housing 5; 10, 20, 30 comprises three main constituent parts 10, 20, 30. A first constituent part is realized by a container 10 for receiving a multiplicity of battery cells 40, a second main constituent part is realized by a support 20 for electrical and/or electronic components 22, and a third constituent part is realized by a cover 30.

According to the invention, it is now additionally provided that the electrical and/or electronic components 22 be disposed, at least partly, on a printed circuit board 24. The electrical components 22 also include, in the widest sense, the cell connectors, since they electrically connect the cell terminals of the battery cells 40 to each other, and electric currents flow through the cell connectors. In this embodiment of the invention, the cell connectors themselves, realized here in the form of bond connections 28, are not disposed on the printed circuit board 24. Alternatively, however, it would be possible for the cell connectors also to be disposed on the printed circuit board 24.

In any case, according to the invention, other electrical and/or electronic components 22 are disposed, at least partly, on the printed circuit board 24, e.g. strip conductors (not represented in figures) that are present, integrated into the printed circuit board 24.

Expediently, the electrical and/or electronic components 22 comprise units for measuring, monitoring, switching and controlling by open-loop and/or closed-loop control. Thus, the electronics system may comprise, for instance, units for monitoring voltage and/or temperature. Particularly preferably, a CSC (“cell supervising circuit”) unit is disposed on the printed circuit board 24.

Advantageously, the printed circuit board 24 comprises a plug-in connector 26, in particular an LV plug-in connector (“low voltage” plug-in connector). A simple means is thus provided for plug-in connection of the printed circuit board 24 for electrical contacting to further electrical units, without the need for a separate component for this purpose.

In order further to improve the sealing of the particularly sensitive regions, seals 25 may be provided at specific points in the housing. Advantageously, the support 20 is sealed off from the interior region of the container 10 by means of at least one seal 25, in particular by means of at least one seal 25 disposed all around a cell terminal of the battery cells 40 to be received. In FIG. 1, incidentally, the seal 25 itself is not represented directly, for reasons of clarity of presentation, but rather its position is indicated. It must be noted again at this pint that FIG. 1 shows a housing 5; 10, 20, 30 according to the invention, or a battery cell module 50 having such a housing 5; 10, 20, 30, in an exploded representation, i.e. in FIG. 1, the main constituent parts 10, 20, 30 of the battery cell module 50, produced to completion, have been represented as spatially separate from each other only to aid comprehension, such that it should be clear that, for instance, the cell connectors, realized here as electrical connections 28 in the form of bond connections, in reality connect and electrically contact the cell terminals of the respectively adjacent battery cells 40 to each other.

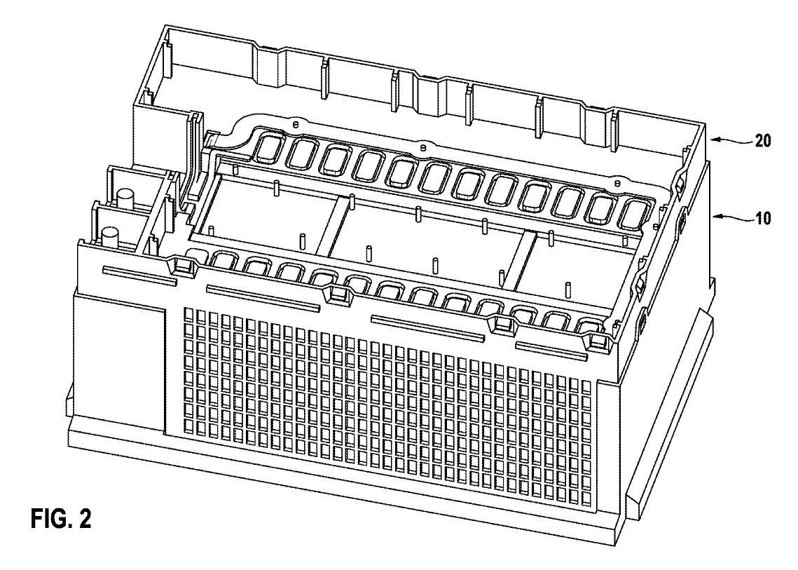

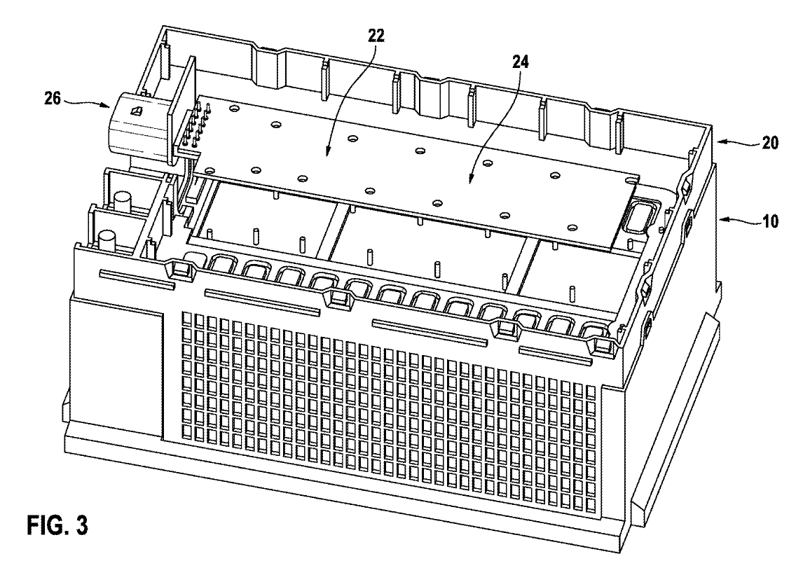

As can be seen in FIG. 2, the support 20 may have openings that correspond with the cell terminals of the battery cells 40 received in the container 10. If the support 20 is disposed on the container 10 with the battery cells 40 received therein, the interior region of the container 10 is covered, with only the cell terminals of the battery cells 40 continuing to be openly accessible through the described openings of the support 20, and thus able to be connected to each other. In the most optimal embodiment, therefore, a seal 25 that goes all around the cell terminal is disposed on each cell terminal of the battery cells 40. The seals 25 in this case, as components that are separate per se, may be disposed singly between the end face of the respective battery cells 40 and the support 20. Alternatively, it is also possible for the seals 25 to exist as integrated components of the support 20. The seals 25 could then, for example, be already fixedly disposed at the openings of the support 20, on the side of the support 20 that faces toward the container 10. The method for producing a battery cell module 50 is described in greater detail later.

In the embodiment of the invention according to FIG. 1, the support 20 may also have a filter 29. The filter 29 is preferably an integrated component in the support 20 and—disposed on the container 10—advantageously protects the interior region of the container 10. As represented in FIG. 1, a possible technical realization of the filter 29 is as a grating element.

In a further embodiment of the invention, not represented in figures, the housing 5; 10, 20, 30, in particular the support 20, may comprise a venting means. This is because it is known that battery cells 40, for example lithium-ion battery cells, may have an internal or external short circuit in the case of improper electrical, mechanical and/or thermal treatment, which may occur, for example, in the case of over-charging of the battery cells 40 or mechanical damage to the battery cell housing, such that they heat up in an unacceptable manner within a very short time. This heating results in a pressure increase in the battery cell 40.

Also in this case, cathode decomposition may occur, with the release of strong oxidizing agents. That can result in a strong exothermic reaction in the electrolyte. In that case hot gases are produced, which increase the pressure inside the battery cell.

This pressure can cause an uncontrollable temperature increase in the cell (so-called “thermal runaway”), and opening of a safety means of the cell such as, for example, a so-called “safety vent” as a result of pressure. If no opening of the cell were to be effected, there is a risk of the cell exploding. It is therefore necessary for media emerging from the battery cell 40, or from the interior of the housing of the battery cell 40, to be discharged in a selective and controlled manner.

The media escaping from the interior of the housing in this case may be liquids and/or gases and/or particles (aerosol); in the present document, they are also referred to collectively as “fluid”, or “fluids”. To that extent, in the present document the term “venting” is also understood to mean, not only the emergence of gases, but also the emergence of liquids and/or particles. The fluids may have undecomposed electrolyte components such as, for example, dimethyl carbonate or ethylene carbonate, or also decomposition products such as carbon monoxide, hydrogen or methane. As a decomposition product of the conducting salt, they may have hydrogen fluoride or phosphoric compounds such as, for example, phosphorous oxytrifluoride (POF3).

Frequently, at least one safety means is disposed at a suitable point on the battery cell housing, for the selective discharging of fluids. It is realized, for example, in the form of a venting valve or bursting membrane—not represented in figures—that forms a vent opening in the case of overheating of the battery cell 40, and thus protects the battery cell 40 from explosion.

It is proposed that the venting means of the housing 5; 10, 20, 30, in particular of the support 20, have seals, which are each preferably disposed between an opening of the support 20 and a venting point corresponding thereto, in particular a venting valve or a bursting membrane, of the battery cell 40 that is to be received. The fluids that may emerge from the battery cells 40 are thus routed in a controlled manner into the interior region of the support 20. Since the interior region of the support 20 is spatially delimited from the interior region of the container 10, the fluid is reliably prevented from escaping into the interior region of the container 10. Incidentally, this advantageous effect occurs even when the interior region of the support 20 is not delimited in an absolutely gas-tight manner from the container 10. Solely as a result of the spatial separation of the two interior regions, without any openly accessible connecting region, the fluid is to a very large extent prevented from escaping from the interior region of the support 20 into the interior region of the container 10. Consequently, if the housing 5; 10, 20, 30, with the battery cells 40 disposed therein, is used, for instance in a vehicle, the fluid also cannot get from the container 10 into the passenger compartment.

In a particularly preferred embodiment, the two interior regions may even be delimited from each other in a gas-tight manner; it thereby becomes virtually totally impossible for the fluid to escape from the interior region of the support 20.

If necessary, the venting means may also comprise lines that interconnect the venting point of the battery cell 40 to the interior region of the support 20. Thus, a possible spatial distance, between the venting point of the battery cell 40 and the opening of the support 40, can be safely overcome.

Finally, the venting means may also comprise a venting collector, which serves as a fluid collector. All fluids are supplied to the venting collector, either via the above-mentioned line or directly from the venting point of the battery cells 40. The venting collector itself may be disposed in the interior region of the container 10, but preferably in the interior region of the support 20.

It is further proposed that the electrical and/or electronic components 22 be at least partly, preferably all, disposed on the side of the support 20 that faces toward the cover 30. Apart from that, in this embodiment, the cover 30 is free from electrical and/or electronic components 22.

The invention additionally provides a battery cell module 50 having a housing 5; 10, 20, 30 according to the invention and battery cells 40 disposed therein. The battery cells 40 in this case are electrically connected to each other and/or to the printed circuit board 24 via electrical connections 28, in particular bond connections.

The battery cell module 50 according to the invention may be used or installed for a great variety of purposes. It is proposed, for example, to provide a motor vehicle, in particular a motor vehicle that can be driven by an electric motor, having a battery cell module 50 according to the invention, wherein the battery cell module 50 is connected to a drive system of the motor vehicle.

Finally, the invention also relates to a method for producing a battery cell module 50 having a housing 5; 10, 20, 30, comprising main constituent parts 10, 20, 30, having the steps:

(a) providing a container (10) for receiving a multiplicity of battery cells (40),
(b) receiving a multiplicity of battery cells (40) into the container (10),
(c) mounting a support (20) for electrical and/or electronic components (22) on the container (10), wherein the electrical and/or electronic components (22) are disposed, at least partly, on a printed circuit board (24), and
(d) mounting a cover (30) on the support (20) and/or container (10).

It is shown in FIG. 2 how, after steps a) and b), i.e. after the providing of a container 10 for receiving a multiplicity of battery cells 40, and after the receiving of the multiplicity of battery cells 40 into the container 10, a support 20 is now mounted on the container 10, according to step c). Here, in step c) the support 20 is first mounted, without the printed circuit board 24, on the container 10.

As represented in FIG. 3, the printed circuit board 24 is then mounted on the support 20. The printed circuit board 24 still has to be electrically connected to the battery cells 40. Further, the battery cells 40 must also be electrically connected to each other. Electrical connections 28 are required for this purpose.

Alternatively, however, it is also possible that in step c) the support 20 is mounted on the container 10 if the printed circuit board 24 is already mounted on the support 20.

In both cases, defined regions for the cell terminals of the battery cells 40 are provided through openings in the support 20. In step c), i.e. during assembly of the support 20 with the container 10, the cell terminals are routed through the openings in the support 20. Thus, even after step c), the cell terminals continue to be accessible from the outside, and can be connected to each other. The seals 25 disposed all around the cell terminals of the battery cells 40 ensure a greater certainty that the support 20 is sealed off from the interior region of the container 10. Thus, for instance, the moisture from the interior region of the container 10 cannot enter the upper region of the support 20 that has the sensitive electronics system.

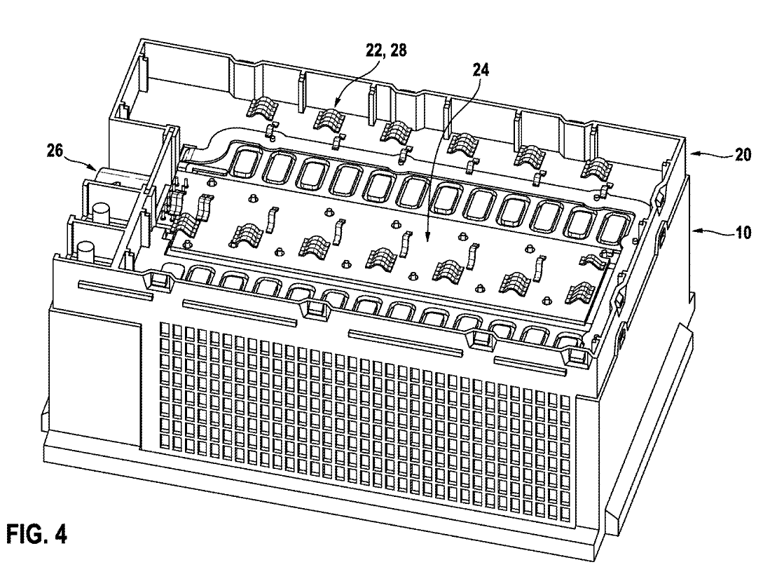

The provision of electrical connections 28 is represented in FIG. 4. Bond connections are represented, as preferred electrical connections 28.

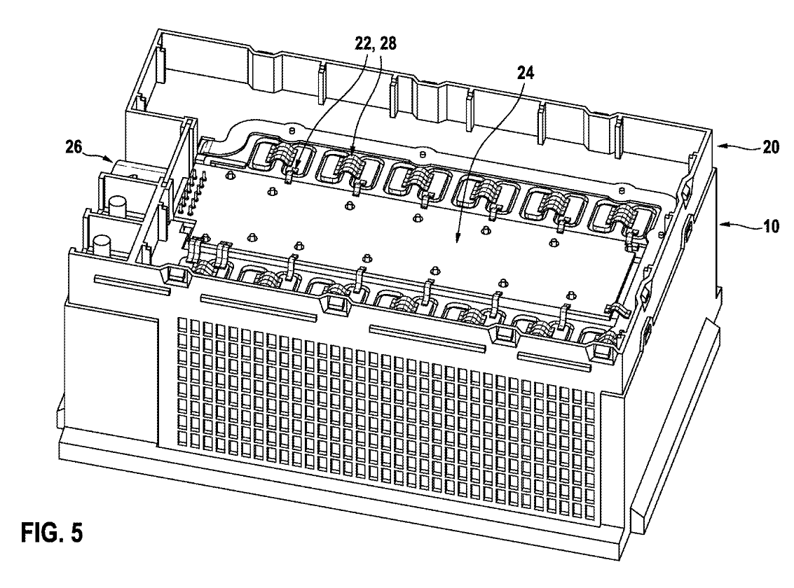

In the production state according to FIG. 5—after step c) and before step d)—an electrical connection 28, in particular a bond connection, is now made between the battery cells 40, interconnecting the latter, and between the battery cells 40 and the printed circuit board 24.

Finally, in step d), a cover 30 is mounted on the support 20 and/or container 10. In the embodiment according to FIG. 1, the cover 30 contacts only the support 20. In principle, however, depending on the design and size ratio of the three main constituent parts in relation to each other, it is possible for the cover 30 simultaneously to contact the support 20 and the container 10, or even only the container 10.

1. A housing (5; 10, 20, 30) for a multiplicity of battery cells (40), wherein the housing (5; 10, 20, 30) comprises three main constituent parts (10, 20, 30), wherein a first constituent part is a container (10) for receiving a multiplicity of battery cells (40), a second main constituent part is a support (20) that supports electrical and/or electronic components (22), and a third constituent part is a cover (30),
characterized in that that
the electrical and/or electronic components (22) are disposed, at least partly, on a printed circuit board (24).

2. The housing (5; 10, 20, 30) as claimed in claim 1,
characterized in that
the support (20) is sealed off from an interior region of the container (10) by at least one seal (25).

3. The housing (5; 10, 20, 30) as claimed in claim 1,
characterized in that
the cover (30) is free from electrical and/or electronic components (22).

4. The housing (5; 10, 20, 30) as claimed in claim 1,
characterized in that
the electrical and/or electronic components (22) are at least partly disposed on a side of the support (20) that faces toward the cover (30).

5. The housing (5; 10, 20, 30) as claimed in claim 1,
characterized in that
the electrical and/or electronic components (22) comprise units for measuring, monitoring, switching and controlling by open-loop and/or closed-loop control.

6. The housing (5; 10, 20, 30) as claimed in claim 5,
characterized in that
the electrical and/or electronic components (22) comprise units for monitoring voltage and/or temperature.

7. The housing (5; 10, 20, 30) as claimed in claim 1,
characterized in that
a CSC (“cell supervising circuit”) unit is disposed on the printed circuit board (24).

8. The housing (5; 10, 20, 30) as claimed in claim 1,
characterized in that
the printed circuit board (24) comprises a plug-in connector (26).

9. A battery cell module (50) having a housing (5; 10, 20, 30) as claimed in claim 1, and battery cells (40) disposed therein.

10. The battery cell module (50) as claimed in claim 9,
characterized in that
battery cells (40) are electrically connected to each other and/or to the printed circuit board (24) via electrical connections (28).

11. A motor vehicle that can be driven by an electric motor, having a battery cell module (50) as claimed in claim 9, wherein the battery cell module (50) is connected to a drive system of the motor vehicle.

12. A method for producing a battery cell module (50) having a housing (5; 10, 20, 30) with three main constituent parts (10, 20, 30), the method comprising the steps:
a) providing a container (10) for receiving a multiplicity of battery cells (40),
b) placing a multiplicity of battery cells (40) into the container (10),
c) mounting a support (20) for electrical and/or electronic components (22) on the container (10), wherein the electrical and/or electronic components (22) are disposed, at least partly, on a printed circuit board (24), and
d) mounting a cover (30) on the support (20) and/or container (10).

13. The method as claimed in claim 12,
characterized in that
in step c) the support (20) is first mounted, without the printed circuit board (24), on the container (10), and the printed circuit board (24) is then mounted on the support (20).

14. The method as claimed in claim 12,
characterized in that
in step c) the support (20) is mounted on the container (10) if the printed circuit board (24) is already mounted on the support (20).

15. The method as claimed in claim 12,
characterized in that
after step c) and before step d) an electrical connection (28) is made between the battery cells (40), interconnecting the latter, and between the battery cells (40) and the printed circuit board (24).

16. The method as claimed in claim 12,
characterized in that
after step c) and before step d) an electrical bond connection is made between the battery cells (40), interconnecting the latter, and between the battery cells (40) and the printed circuit board (24).

17. The housing (5; 10, 20, 30) as claimed in claim 1,
characterized in that
the support (20) is sealed off from an interior region of the container (10) by at least one seal (25) disposed all around a cell terminal of the battery cells (40) to be received.

18. The housing (5; 10, 20, 30) as claimed in claim 1,
characterized in that
the electrical and/or electronic components (22) are all disposed on a side of the support (20) that faces toward the cover (30).

19. The housing (5; 10, 20, 30) as claimed in claim 1,
characterized in that
the printed circuit board (24) comprises an LV plug-in connector (“low voltage” plug-in connector).

20. The battery cell module (50) as claimed in claim 9,
characterized in that
battery cells (40) are electrically connected to each other and/or to the printed circuit board (24) via electrical bond connections.
